(19) United States
(12) Patent Application Publication
(10) Pub. No.: US 2017/0373453 A1
(43) Pub. Date: Dec. 28, 2017

(54) Crimping Tool

(71) Applicant: Hanlong Industrial Co., Ltd., New Taipei City (TW)

(72) Inventors: Chien-Chou Liao, New Taipei City (TW); Wan-Yu Chiang, New Taipei City (TW)

(21) Appl. No.: 15/236,583

(22) Filed: Aug. 15, 2016

(30) Foreign Application Priority Data
Jun. 24, 2016 (TW) 105209581

(51) Int. Cl. H01R 43/042; B25B 27/14; H01R 4/18; H01R 24/62

(52) U.S. Cl. CPC H01R 43/0421; H01R 24/62; B25B 27/14; H01R 4/186

(57) ABSTRACT

A crimping tool used for crimping terminals and wires includes a driving mechanism, a crimping mechanism and a plurality of adjustable elements. The crimping mechanism includes a compensation element and a crimping block, wherein the compensation element includes an accommodating space, an accommodating groove and a plurality of through holes. The accommodating groove and the through holes communicate with the accommodating space. The accommodating groove is used for accommodating the terminal. The crimping block is connected to the driving mechanism and movably disposed in the accommodating space. Each of the adjustable elements is movably disposed in each of the through holes such that it can be moved into the accommodating space to be against the crimping block such that the convex teeth of the crimping block are aligned with a plurality of pins on the terminal.

### BACKGROUND OF THE INVENTION

### 1. Field of the Invention

The present invention relates to a crimping tool, particularly to a crimping tool used for crimping network or telephone terminals.

### 2. Description of the Related Art

With the popularity of the Internet, most homes are connected to the internet. At present, most of these homes are connected to the internet with a wired connection; that is, signals are transmitted through network lines deployed by a telecom company. The network lines need to be electrically connected to electronic devices through network terminals. Accordingly, crimping tools used for crimping network terminals and the network lines have been developed.

Since network terminals are equipped with a plurality of elongated pins, a crimping block of a crimping tool is correspondingly provided with a plurality of convex teeth. However, due to the tolerance of a conventional crimping tool generated during the manufacturing process, sometimes the plurality of convex teeth may not be accurately aligned with a plurality of pins. Therefore, during crimping, the crimping block may crush one or more pins.

### SUMMARY OF THE INVENTION

It is a major objective of the present invention to provide a crimping tool having a crimping block with adjustable convex teeth that can be aligned with the pins of a terminal.

To achieve the above objective, the crimping tool of the present invention is used for crimping a terminal to an end of a wire. Specifically, the terminal includes a plurality of pins. The crimping tool of the present invention includes a driving mechanism, a crimping mechanism and a plurality of adjustable elements. The crimping mechanism includes a compensation element and a crimping block. The compensation element includes two side walls opposite each other and an anterior wall. Both ends of the anterior wall are connected to each of the side walls. An accommodating space and at least one accommodating groove are disposed between the two side walls. The accommodating groove is located between the accommodating space and the anterior wall, and connected with the accommodating space. The accommodating groove is used for accommodating the terminal. A through hole is provided on each of the two side walls respectively. Each of the through holes is connected with the accommodating space. The crimping block is disposed in the accommodating space and connected to the driving mechanism. The driving mechanism is used for moving the crimping block toward the accommodating groove under a user's operation. Specifically, the crimping block includes at least one clamping tooth which corresponds to the accommodating groove and includes a plurality of convex teeth. Each of the plurality of adjustable elements is movably disposed in each of the through holes such that it can be moved into the accommodating space to be against the crimping block such that the plurality of convex teeth can be aligned with the plurality of pins.

According to an embodiment of the present invention, the driving mechanism includes a first clamp handle, a second clamp handle, a first connecting plate, and a second connecting plate. The second clamp handle is pivotally connected to the first clamp handle. The crimping block is connected to the pivot of the first clamp handle and the second clamp handle. The first connecting plate is pivotally connected to the first clamp handle. The second connecting plate is pivotally connected to the second clamp handle and the first connecting plate.

According to an embodiment of the present invention, the driving mechanism further includes a pair of springs. An end of one of springs is connected to the first clamp handle, and the opposite end of the spring is connected to the first connecting plate. An end of the other spring is connected to the second clamp handle, and the opposite end of the other spring is connected to the second connecting plate.

According to an embodiment of the present invention, the number of the at least one accommodating groove is plural, and the size of each of the accommodating grooves is different; the number of the at least one clamping tooth is plural. The clamping teeth respectively correspond in position to each of the accommodating grooves.

According to an embodiment of the present invention, the crimping tool of the present invention further includes a first blade. The first clamp handle includes a groove for the first blade to be disposed therein. The first blade is used for severing the wire.

According to an embodiment of the present invention, the crimping tool of the present invention further includes a bracket and a second blade. The bracket is connected to the second clamp handle. The second blade is connected to the first connecting plate and corresponds to the bracket.

According to an embodiment of the present invention, the adjustable element is a threaded pin.

According to an embodiment of the present invention, the driving mechanism includes the first clamp handle, the second clamp handle, and the first connecting plate. The first clamp handle is connected to the crimping block. The second clamp handle is connected to the compensation element. An end of the first connecting plate is connected to the first clamp handle, and the opposite end of the first connecting plate is connected to the second clamp handle.

According to an embodiment of the present invention, the driving mechanism includes the first clamp handle, the second clamp handle, and the first connecting plate. The second clamp handle is pivotally connected to the first clamp handle. An end of the first connecting plate is connected to the first clamp handle, and the opposite end of the first connecting plate is connected to the crimping block.

### BRIEF DESCRIPTION OF THE DRAWINGS

The exemplary embodiment(s) of the present invention will be understood more fully from the detailed descriptions given below and from the accompanying drawings of various embodiments of the invention, which should not be taken to limit the invention to the specific embodiments but are for explanation and understanding only.

FIG. 1 is a side elevational view of a crimping tool according to a first embodiment of the present invention;

FIG. 2 is an exploded view of a crimping tool according to the first embodiment of the present invention;

FIG. 3 is a schematic drawing of a crimping tool before crimping;

FIG. 4 is a schematic drawing of a crimping tool after crimping;

FIG. 5 is another side elevational view of the crimping tool according to the first embodiment of the present invention;

FIG. 6A is a partial cross-sectional view in the direction A-A as shown in FIG. 5, illustrating the convex teeth not aligned with the pins;

FIG. 6B is a partial cross-sectional view in the direction A-A as shown in FIG. 5, illustrating the convex teeth aligned with the pins;

FIG. 7 is a lateral view of a crimping tool according to a second embodiment of the present invention; and

FIG. 8 is a lateral perspective view of a crimping tool according to a third embodiment of the present invention.

### DETAILED DESCRIPTION OF THE PREFERRED EMBODIMENT

Hereinafter, the technical content of the present invention will be better understood with reference to the preferred embodiments.

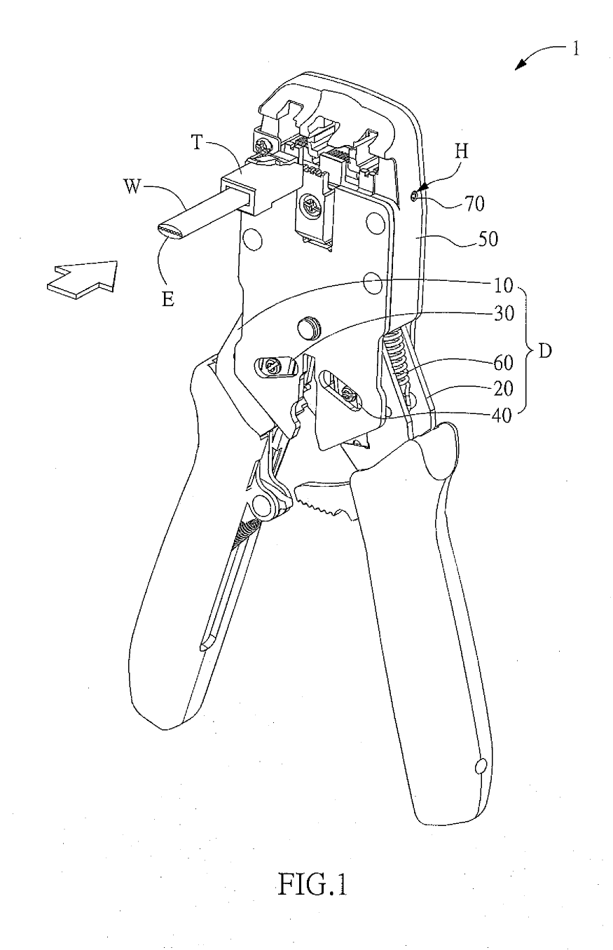

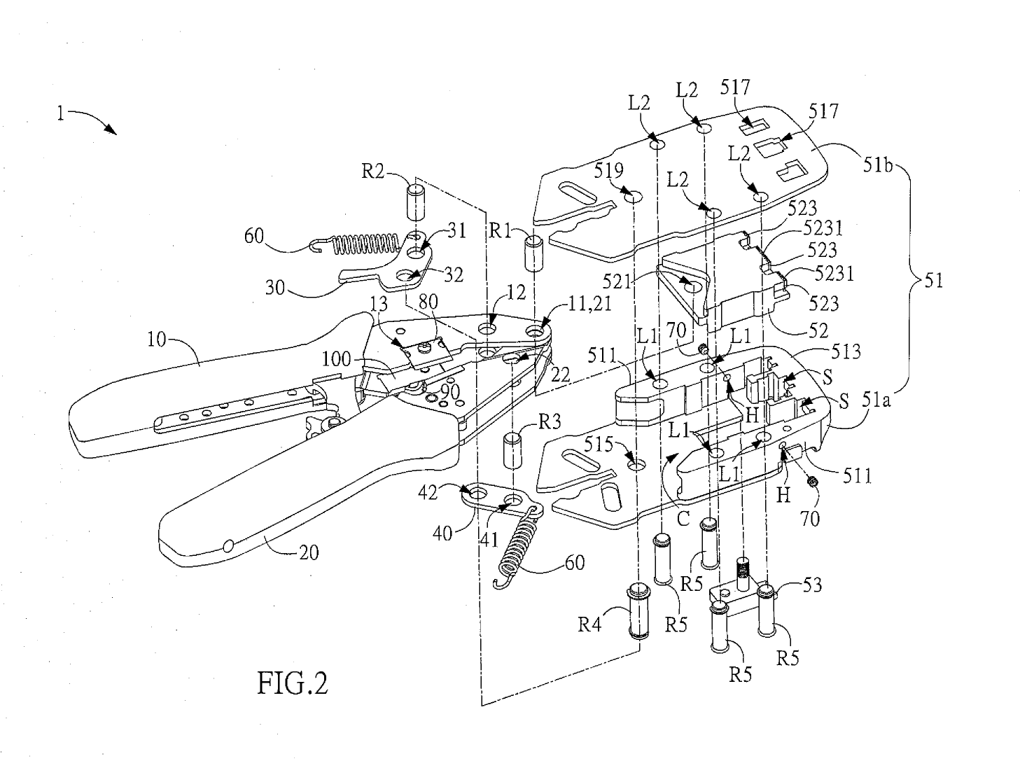

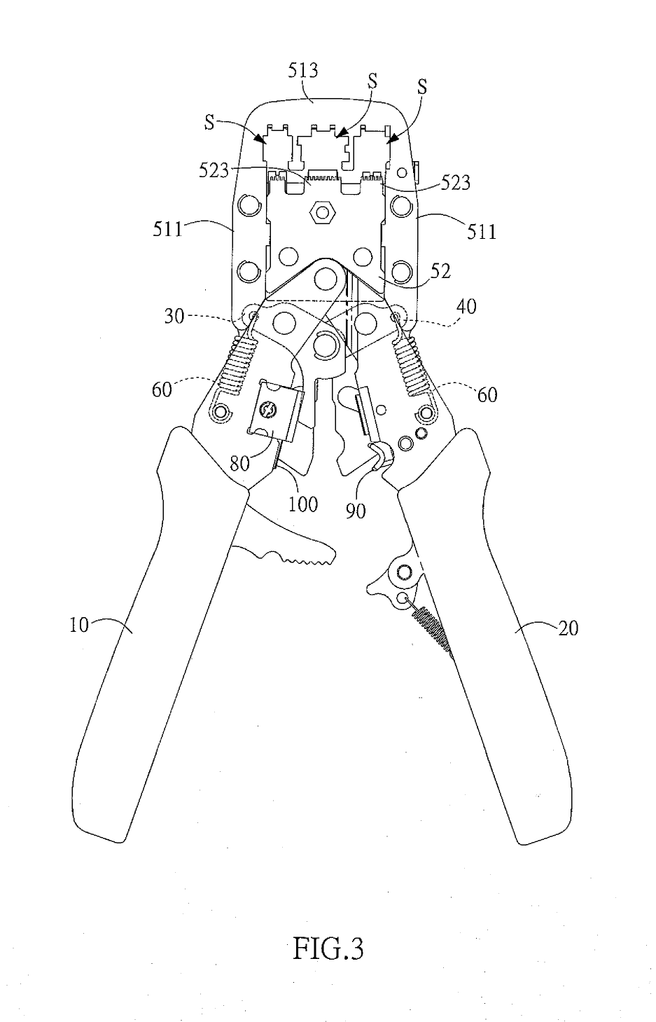

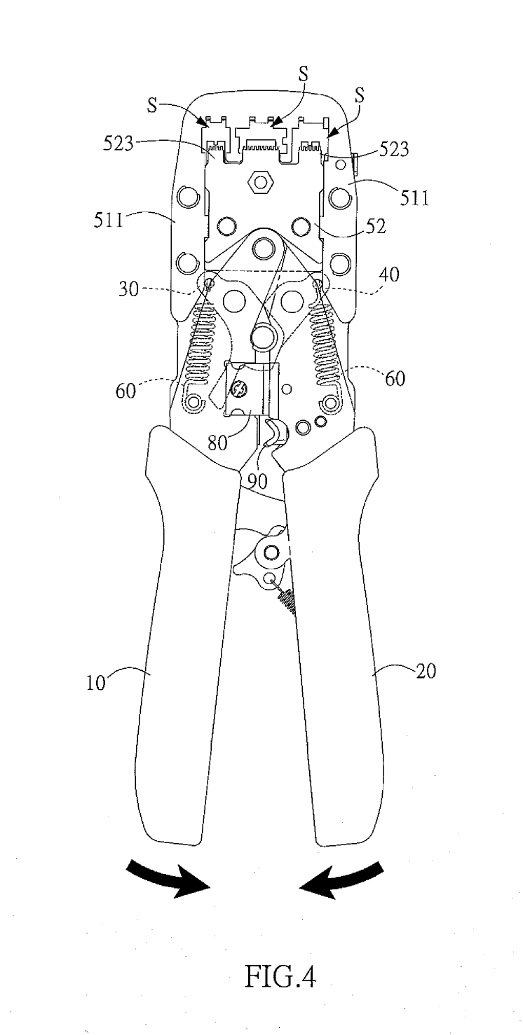

Hereinafter, please also refer to FIGS. 1 to 4. Specifically, FIG. 1 is a lateral plan view of a crimping tool according to a first embodiment of the present invention; FIG. 2 is an exploded view of a crimping tool according to the first embodiment of the present invention; FIG. 3 is a schematic drawing of a crimping tool before crimping; and FIG. 4 is a schematic drawing of a crimping tool after crimping.

As shown in FIG. 1, the crimping tool 1 of the present invention is used to crimp a terminal T to an end of a wire W, wherein the terminal T includes a plurality of pins (not shown in FIG. 1). In a specific embodiment of the present invention, the terminal T is a network terminal, and the wire W is a network transmission line, but the present invention is not limited thereto. For example, the terminal T may be a telephone terminal, and the wire W may be a telephone wire.

As shown in FIG. 1 and FIG. 2, in a first embodiment of the present invention, the crimping tool 1 includes a driving mechanism D, a crimping mechanism 50, a pair of adjustable elements 70, a first blade 80, a bracket 90 and a second blade 100.

In the first embodiment of the present invention, the driving mechanism D includes a first clamp handle 10, a second clamp handle 20, a first connecting plate 30, a second connecting plate 40 and a pair of springs 60.

The first clamp handle 10 includes a pivot hole 11, a connection hole 12 and a groove 13. The second clamp handle 20 includes a pivot hole 21 and a connection hole 22. The second clamp handle 20 is pivotally connected to the first clamp handle 10 by a rivet R1 passing through the pivot holes 11 and 21. The first connecting plate 30 includes a front hole 31 and a rear hole 32. The first connecting plate 30 is pivotally connected to the first clamp handle 10 by a rivet R2 passing through the front hole 31 and the connection hole 12 of the first clamp handle 10. The second connecting plate 40 includes a front hole 41 and a rear hole 42. The second connecting plate 40 is pivotally connected to the second clamp handle 20 by a rivet R3 passing through the front hole 41 and the connection hole 22 of the second clamp handle 20. The second connecting plate 40 is pivotally connected to the first connecting plate 30 by a rivet R4 passing through the rear holes 42 and 32. The first clamp handle 10, the second clamp handle 20, the first connecting plate 30 and the second connecting plate 40 form a four-bar linkage mechanism (as shown in FIG. 3). An end of one of the pair of springs 60 is connected to the first clamp handle 10, and the opposite end of the spring 60 is connected to the first connecting plate 30. An end of the other spring 60 is connected to the second clamp handle 20, and the opposite end of the other spring is connected to the second connecting plate 40. The pair of springs 60 provide a spring force to the first connecting plate 30 and the second connecting plate 40, such that the first clamp handle 10 and the second clamp handle 20 are kept in a state of not clamping (the state shown in FIG. 3).

In the first embodiment of the present invention, the crimping mechanism 50 includes a compensation element 51, a crimping block 52 and a bracket block 53. The compensation element 51 includes a seat body 51a and a cover plate 51b. The seat body 51a includes two side walls 511 opposite each other, an anterior wall 513 and an axle hole 515. Two ends of the anterior wall 513 are connected to each of the side walls 511 respectively. An accommodating space C and three accommodating grooves S of different sizes are provided between the two side walls 511. Each of the side walls 511 includes a through hole H and a pair of lock holes L1. The three accommodating grooves S are located between the accommodating space C and the anterior wall 513, and communicate with the accommodating space C. Each of the through holes H communicates with the accommodating space C. The cover plate 51b includes three openings 517, an axle hole 519 and a plurality of lock holes L2. The cover plate 51b is assembled with the seat body 51a by a plurality of rivets R5 passing through the lock holes L1 and L2. The first connecting plate 30 and the second connecting plate 40 are pivotally connected to the compensation element 51 by a rivet R4 passing through the rear holes 32 and 42 and the axle holes 515 and 519. After the cover plate 51b is assembled with the seat body 51a, each of the three openings 517 corresponds to and communicates with each of the accommodating grooves S.

The crimping block 52 includes a connection hole 521 and three clamping teeth 523 of different widths. The crimping block 52, which is disposed in the accommodating space C, is connected to a pivot of the first clamp handle 10 and the second clamp handle 20 by the rivet R1 passing through the connection hole 521 and the pivot holes 11 and 21. Each of the clamping teeth 523 corresponds to each of the accommodating grooves S and includes a plurality of convex teeth 5231. As shown in FIG. 3, when the first clamp handle 10 and the second clamp handle 20 are not moved toward each other by a clamping force, the clamping teeth 523 do not enter the corresponding accommodating grooves S. At this time, the terminal T having the corresponding size (as shown in FIG. 1) can be accommodated in each of the accommodating grooves S. After a terminal T installed at an end of a wire W is placed into the accommodating groove S, the first clamp handle 10 and the second clamp handle 20 are moved toward each other by a user applying a clamping force, whereupon the first connecting plate 30 and the second connecting plate 40 are driven to rotate such that the first connecting plate 30 and the second connecting plate 40 push the crimping block 52 to move toward the accommodating groove S (as shown in FIG. 4), such that the terminal T in the accommodating groove S and the wire W are connected to each other by a crimping connection. In other words, under a user's operation, the driving mechanism D can drive the crimping block 52 to move toward the accommodating groove S.

The bracket block 53 is assembled with the compensation element 51 and corresponds to one of the accommodating grooves S. The bracket block 53 is used to immobilize the terminal T when the wire W is placed into the accommodating groove S.

In the first embodiment of the present invention, each of the adjustable elements 70 is movably disposed in each of the through holes H such that it can be moved into the accommodating space C to be against the crimping block 52. In an embodiment of the present invention, each adjustable element 70 is a threaded pin, but the present invention is not limited thereto.

In an embodiment of the present invention, the first blade 80 is assembled and disposed in the groove 13 of the first clamp handle 10. The first blade 80 is used to sever the wire W.

In an embodiment of the present invention, the bracket 90 is connected to the second clamp handle 20 and is used for accommodating a tubular wire (not shown). The second blade 100 is connected to the first clamp handle 10 and disposed corresponding to the bracket 90. The second blade 100 is used for cutting off an outer layer of the tubular wire located on the bracket 90.

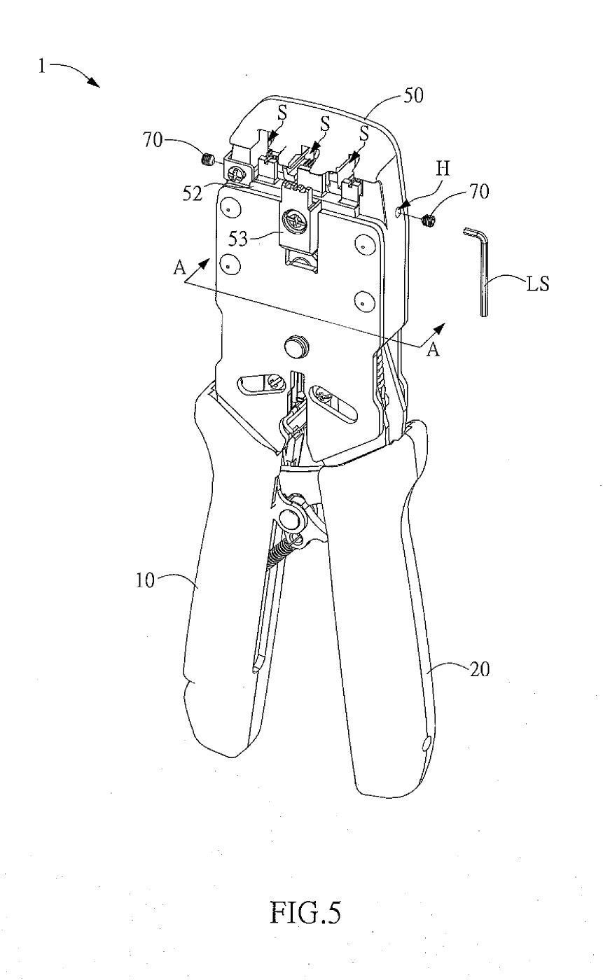

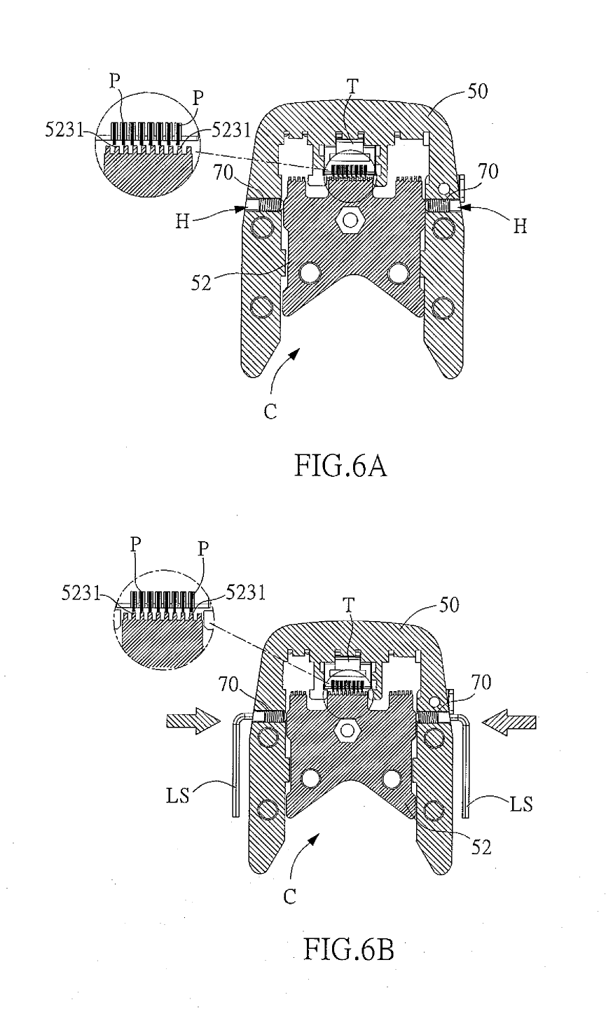

Please also refer to FIGS. 1, 2, 5, and 6. Specifically, FIG. 5 is another side elevational view of the crimping tool according to the first embodiment of the present invention; FIG. 6A is a partial cross-sectional view in the direction A-A as shown in FIG. 5, illustrating the convex teeth not aligned with the pins; and FIG. 6B is a partial cross-sectional view in the direction A-A as shown in FIG. 5, illustrating the convex teeth aligned with the pins.

As shown in FIGS. 2 and 5, since the manufacturing process of the compensation element 51 may produce tolerance, the plurality of pins P on the terminal T may not be accurately aligned with the plurality of convex teeth 5231 of the crimping block 52 when a user places the terminal T into the accommodating groove S (as shown in FIG. 6A). In such a case, the user who is using the crimping tool 1 of the present invention can use a screwdriver LS or another tool to move the adjustable element 70 into the accommodating space C to be against the crimping block 52 such that the plurality of convex teeth 5213 can be aligned with the plurality of pins P by the movement of the adjustable element 70 (as shown in FIG. 6B).

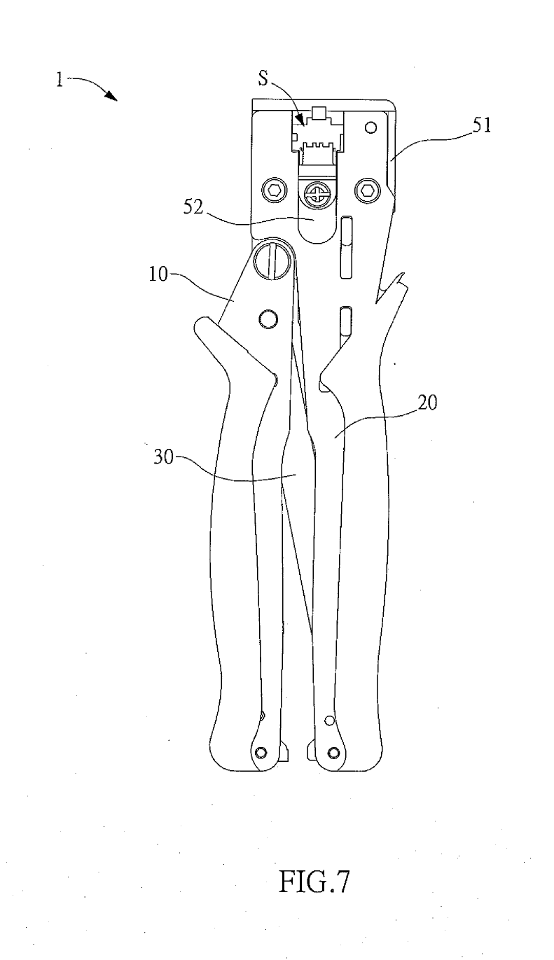

Please refer to FIG. 7 for a schematic drawing of a crimping tool according to a second embodiment of the present invention.

As shown in FIG. 7, the second embodiment of the present invention differs from the first embodiment of the present invention in that the driving mechanism D includes the first clamp handle 10, the second clamp handle 20 and a first connecting plate 30. The first clamp handle 10 is connected to the crimping block 52, and the second clamp handle 20 is connected to the compensation element 51. An end of the first connecting plate 30 is connected to the first clamp handle 10, and the opposite end of the first connecting plate 30 is connected to the second clamp handle 20. When the first clamp handle 10 rotates toward the second clamp handle 20 such that the two clamp handles are moved toward each other, the crimping block 52 is driven by the first connecting plate 30 to move toward the accommodating groove S. Since the assembly relationships of the components of the crimping mechanism 50 of the crimping tool 1, the arrangement of the adjustable element 70, and the adjustment of the crimping block 52 in the second embodiment are the same as those in the first embodiment, they will not be repeated hereinafter.

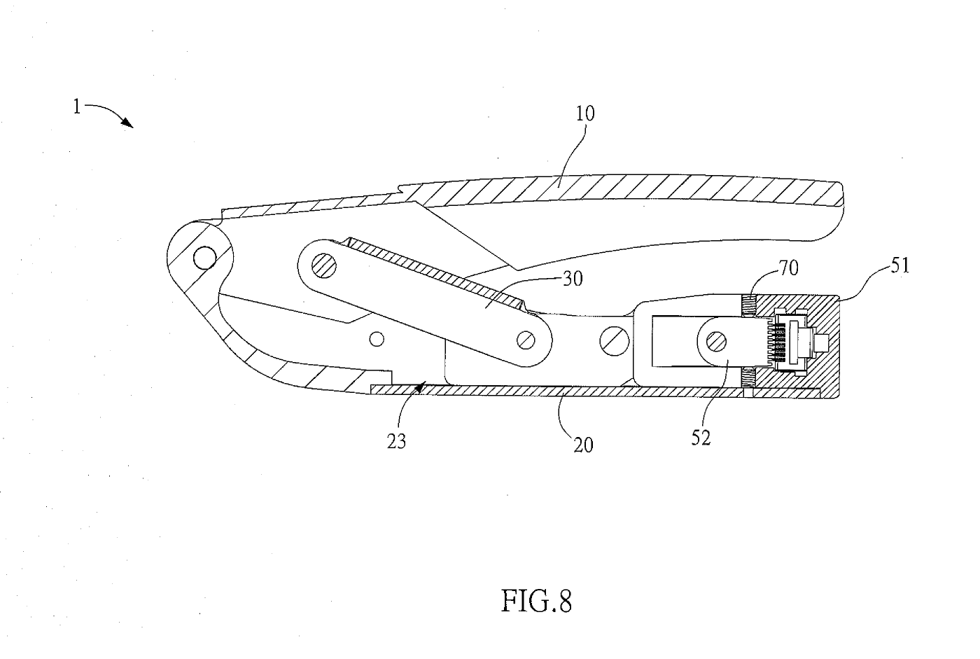

Finally, please also refer to FIG. 8 for a schematic drawing of a crimping tool according to a third embodiment of the present invention.

As shown in FIG. 8, the third embodiment differs from the embodiments disclosed above in the design of the driving mechanism D, which also includes a first clamp handle 10, a second clamp handle 20 and a first connecting plate 30. The second clamp handle 20 is pivotally connected to the first clamp handle 10, and the second clamp handle 20 includes a chute 23. An end of the first connecting plate 30 is connected to the first clamp handle 10, and the opposite end of the first connecting plate 30 is connected to the crimping block 52. The compensation element 51 is assembled and disposed at one end of the second clamp handle 20. The crimping block 52 is movably disposed in the chute 23 of the second clamp handle 20. When the first clamp handle 10 is rotated toward the second clamp handle 20 and the two clamp handles are moved toward each other, the crimping block 52 is driven by the first connecting plate 30 to move toward the accommodating groove S. Since the assembly relationships of the components of the crimping mechanism C of the crimping tool 1, the arrangement of the adjustable elements 70 and the adjustment of the crimping block 52 in the third embodiment are the same as those in the first embodiment, they will not be repeated hereinafter.

It should be noted that the described embodiments are for illustrative and exemplary purposes only. To avoid redundancy, not all of the possible combinations of changes are described in detail herein. However, those skilled in the art will understand that not all the components are necessary. For implementation, the present invention may also contain other detailed conventional components. Each component can be omitted or modified depending on demands. Also, other elements may not necessarily exist between any two components. For example, the aforementioned through hole H which allows the adjustable element 70 to be disposed therein may not be located on the seat body 51a, for it may also be disposed on the cover plate 51b. In addition, the driving mechanism D of the crimping tool 1 is a conventional technique which could be employed in a variety of embodiments and aspects and anticipated by those skilled in the art with ordinary knowledge. Any driving mechanism capable of realizing the crimping function should be applicable to the present invention. In the claims of the present invention, the driving mechanism D should not be limited to the described embodiments.

As described above, the objective, means, and effects of the present invention are all different from those of the prior art. It should be noted that the described embodiments are for illustrative and exemplary purposes only, and that various changes and modifications may be made to the described embodiments without departing from the scope of the invention as stated in the appended claims.

What is claimed is:

1. A crimping tool, which is used for crimping a terminal to an end of a wire, wherein the terminal comprises a plurality of pins, the crimping tool comprising:
a driving mechanism;
a crimping mechanism, comprising:
a compensation element, which comprises two side walls opposite each other and an anterior wall whose two ends are connected to each of the two side walls; an accommodating space and at least one accommodating groove are provided between the two side walls, and the at least one accommodating groove is located between the accommodating space and the anterior wall; the at least one accommodating groove communicates with the accommodating space for accommodating the terminal, wherein each of the two side walls is provided with a through hole, and each of the through holes communicates with the accommodating space; and
a crimping block, disposed in the accommodating space and pivoted to the driving mechanism, the driving mechanism being used to enable the crimping block to move toward the at least one accommodating groove under a user's operation; the crimping block comprising at least one clamping tooth which corresponds in position to the at least one accommodating groove, and the at least one clamping tooth comprising a plurality of convex teeth; and
a plurality of adjustable elements, which are movably disposed in each of the through holes respectively such that they can be moved into the accommodating space to be against the crimping block, such that the plurality of convex teeth can be aligned with the plurality of pins.

2. The crimping tool as claimed in claim 1, wherein the driving mechanism comprises:
a first clamp handle;
a second clamp handle, which is pivotally connected to the first clamp handle, the crimping block being connected to a pivot of the first clamp handle and the second clamp handle;
a first connecting plate, which is pivotally connected to the first clamp handle; and
a second connecting plate, which is pivotally connected to the second clamp handle and the first connecting plate.

3. The crimping tool as claimed in claim 2, wherein the driving mechanism further comprises a pair of springs, in which an end of one spring is connected to the first clamp handle, and the opposite end thereof is connected to the first connecting plate; an end of the other spring is connected to the second clamp handle, and the opposite end thereof is connected to the second connecting plate.

4. The crimping tool as claimed in claim 2, wherein the number of the at least one accommodating groove is plural, and the size of each of the accommodating grooves is different; the number of the at least one clamping tooth is plural, and the plurality of clamping teeth respectively correspond to each of the accommodating grooves.

5. The crimping tool as claimed in claim 2, further comprising a first blade, the first clamp handle comprising a groove; the first blade is assembled and disposed in the groove for severing the wire.

6. The crimping tool as claimed in claim 2, further comprising a bracket and a second blade, the bracket being connected to the second clamp handle and the second blade being connected to the first clamp handle and corresponding in position to the bracket.

7. The crimping tool as claimed in claim 1, wherein the adjustable element is a threaded pin.

8. The crimping tool as claimed in claim 1, wherein the driving mechanism comprises:
a first clamp handle, which is connected to the crimping block;
a second clamp handle, which is connected to the compensation element; and
a first connecting plate, one end of which is connected to the first clamp handle, and the other end of which is connected to the second clamp handle.

9. The crimping tool as claimed in claim 1, wherein the driving mechanism comprises:
a first clamp handle;
a second clamp handle, which is pivotally connected to the first clamp handle; and
a first connecting plate, one end of the first connecting plate being connected to the first clamp handle and another end of the first connecting plate being connected to the crimping block.
